(19) United States
(12) Patent Application Publication
(10) Pub. No.: US 2015/0056597 A1
(43) Pub. Date: Feb. 26, 2015

(54) SYSTEM AND METHOD FACILITATING ADAPTIVE LEARNING BASED ON USER BEHAVIORAL PROFILES

(71) Applicant: LoudCloud Systems Inc., Dallas, TX (US)

(72) Inventors: Manoj Kutty, Dallas, TX (US); Anil Vishwanath Sonkar, Andheri (IN); Amit Bansal, Mumbai (IN); Bibekananda Pahi, Keonjhar (IN); Debdip Pal, Kolkata (IN); Angarika Patil, Navi Mumbai (IN); Venkata Datla, Mumbai (IN)

(73) Assignee: LoudCloud Systems Inc., Dallas, TX (US)

(21) Appl. No.: 13/973,725

(22) Filed: Aug. 22, 2013

(51) Int. Cl. G09B 7/08

(52) U.S. Cl. CPC G09B 7/08
USPC 434/350

(57) ABSTRACT

Methods and systems for adaptively assigning a questionnaire to a user are disclosed. In one embodiment, a transactional data and log data associated with activities performed by each user of a plurality of users may be captured. The transactional data and the log data may be analyzed to retrieve a first set of parameters and a second set of parameters. A profile for each user of the plurality of users may be generated by analyzing the first set of parameters. A complexity index value of each questionnaire of the plurality of questionnaires may be determined by analyzing the second set of parameters. The profile of each user of the plurality of users may be matched with the complexity index value of each questionnaire of the plurality of questionnaires. Based upon the matching, at least one questionnaire from the plurality of questionnaires may be assigned to the user.

### TECHNICAL FIELD

The present subject matter described herein, in general, relates to learning management systems and, more particularly, to the learning management systems for assigning questioners to a user based on a behavioral profile of the user.

### BACKGROUND

With the enormous growth of learning management systems (LMS) or e-learning systems over the past years, e-learning systems have already become an integral part of the learning tools used by educational organizations, Government institutions and other institutions. E-learning systems redefine teaching/learning processes and the overall learning environment by facilitating electronic/technological support learning, teaching through virtual classrooms, self-paced learning, asynchronous learning, or instructor-led synchronous learning. E-learning systems further facilitate instructors, teachers, mentors or any other online tutors to educate students or observers remotely in a structured manner, and to conduct an online assessment test. The assessment test may be conducted by way of assigning online assessment including quizzes, multiple-choice questions (MCQs), objective question sets, and subjective question sets etc.

In a learning management system (LMS), a traditional approach is followed for assessment of question sets for students in the same class. In the traditional approach, each of the students of the same class is assigned with a similar set of question sets. The understanding level of each of the students may be different, and the capability of each of the students to solve a specific question set may vary. Each of the questions in the question sets may have different complexity level, and each of the students in the class may adapt with the complexity of each questions in a different manner. One student may require more time to solve a specific question, while the other students in the class may find the same question comparatively easy and hence solve the question in comparatively less time. There is no systematic process that enables setting of complexity level of the question sets, and usually it is decided by the instructor/teacher manually. This results in facilitation of non-personalized question sets to the students through the LMS, wherein all the students of the same class get same question sets for the assessments.

### SUMMARY

This summary is provided to introduce aspects related to e-learning systems and methods for assigning questionnaires to a user and the aspects are further described below in the detailed description. This summary is exemplary and explanatory only; it is not intended to identify features of the claimed subject matter nor is it intended for use in determining or limiting the scope of the claimed subject matter.

In one implementation, a learning management system for assigning at least one questionnaire from a plurality of questionnaires to a user is disclosed. The user may be a student or an administrator on the learning management platform. The learning management system comprises a processor and a memory coupled to the processor wherein the processor is capable of executing instructions stored in the memory. The instructions may comprise instructions for: capturing transactional data and log data associated with activities performed by each user of a plurality of users; analyzing the transactional data and the log data to retrieve a first set of parameters and a second set of parameters; generating a profile for each user of the plurality of users by analyzing the first set of parameters; determining complexity index value of each questionnaire of the plurality of questionnaires by analyzing the second set of parameters; matching the profile of each user with the complexity index value of each questionnaire and assigning at least one questionnaire from the plurality of questionnaires to the user based upon the matching of the profile of the user with the complexity index value of the at least one questionnaire.

In another implementation, a learning management method for assigning at least one questionnaire from a plurality of questionnaires to a user is disclosed. The learning management method may comprise a step of capturing transactional data and log data associated with activities performed by each user of a plurality of users. The learning management method may further comprise a step of analyzing the transactional data and the log data to retrieve a first set of parameters and a second set of parameters. The first set of parameters may be indicative of evaluation of each user of the plurality of users based on the activities performed. The second set of parameters may be indicative of evaluation of complexity of each questionnaire of the plurality of questionnaires. The learning management method may further comprise a step of generating a profile for each user of the plurality of users by analyzing the first set of parameters. The learning management method may further comprise a step of determining complexity index value of each questionnaire of the plurality of questionnaires by analyzing the second set of parameters. Further, the learning management method may comprise a step of matching the profile of each user with the complexity index value of each questionnaire. Further, the learning management method may comprise a step of assigning module at least one questionnaire from the plurality of questionnaires to the user based upon the matching of the profile of the user with the complexity index value of the at least one questionnaire. In this implementation, the capturing, the analyzing, the generating, the determining, the matching, and the assigning are performed by a processor using computer executable instructions stored in a memory.

In yet another implementation, a non-transitory computer program product having embodied thereon computer-readable learning management instructions for assigning at least one questionnaire from a plurality of questionnaires to a user is disclosed. The computer-readable learning management instructions may comprise instructions for: capturing transactional data and log data associated with activities performed by each user of a plurality of users; analyzing the transactional data and the log data to retrieve a first set of parameters and a second set of parameters; generating a profile for each user of the plurality of users by analyzing the first set of parameters; determining complexity index value of each questionnaire of the plurality of questionnaires by analyzing the second set of parameters; matching the profile of each user with the complexity index value of each questionnaire and assigning at least one questionnaire from the plurality of questionnaires to the user based upon the matching of the profile of the user with the complexity index value of the at least one questionnaire.

### BRIEF DESCRIPTION OF THE DRAWINGS

The foregoing summary, as well as the following detailed description of embodiments, is better understood when read in conjunction with the appended drawings. For the purpose of illustrating the disclosure, there is shown in the present document example constructions of the disclosure, however, the disclosure is not limited to the specific methods and apparatuses disclosed in the document and the drawings.

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a learning management system for assigning at least one questionnaire from a plurality of questionnaires to a user is shown, in accordance with an embodiment of the present subject matter.

FIG. 2 illustrates the learning management system, in accordance with an embodiment of the present subject matter.

FIG. 3 illustrates detailed working of the components of the learning management system, in accordance with an embodiment of the present subject matter.

FIG. 4 illustrates a learning management method for at least one questionnaire from a plurality of questionnaires to a user, in accordance with an embodiment of the present subject matter.

The figures depict various embodiments of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

Some embodiments of this disclosure, illustrating all its features, will now be described in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

System(s) and method(s) for assigning at least one questionnaire (hereinafter also referred as “question” interchangeably) from a plurality of questionnaires hereinafter also referred as “questions” interchangeably) to a user are described. In one embodiment, the plurality of questionnaires may be at least one of a quiz, a question, a multiple choice question (MCQ), a puzzle, a subjective question, and an objective question. The plurality of questionnaires may be stored in a repository. In one embodiment, transactional data and log data associated with activities performed by each user of a plurality of users may be captured. The activities may be performed by each user on at least one entity, wherein the at least one entity may comprise an assessment, a class, a forum, a quiz, a course, a grade-book, an analytics, a virtual classroom and a program. In one example, the activities performed by each user may comprise at least one of attempting at least one questionnaire in the assessment, publishing a post in the forum, participating in the quiz, navigating a content of the course and a combination thereof. In one embodiment, the transactional data may comprise a score obtained in at least one of the quiz, the forum and the assessment, amount of content referred in the course, number of questionnaires attempted, peer points obtained in the forum and a combination thereof. Further, the log data may comprise time spent on at least one of the course, the quiz, the questionnaire and the forum, number of quizzes attempted, number of forums initiated, number of substantive posts in the forums and a combination thereof.

In one embodiment, the transactional data and the log data may be analyzed for retrieving of a first set of parameters and a second set of parameters. In an embodiment, the transactional data and the log data may be captured in an unstructured form. The transactional data and the log data in unstructured form may be processed by using extraction, transformation and loading (ETL) process to derive a structured data. The structured data may then be processed to obtain the first set of parameters and the second set of parameters. The first set of parameters may be indicative of the evaluation of each user of the plurality of users based on the activities performed. The second set of parameters may be indicative of evaluation of complexity of each questionnaire of the plurality of questionnaires. In one example, the first set of parameters may comprise at least one of a score, a time, a participation level, an adaptive learning and a practice level. The second set of parameters may comprise at least one of rate of appearance, attempt rate, attempt time and question comparative value.

In one embodiment, a profile for each user of the plurality of users may be generated by analyzing the first set of parameters. Further, a complexity index value of each questionnaire of the plurality of questionnaires may be determined by analyzing the second set of parameters. The complexity index value may be indicative of a difficulty level of each questionnaire of the plurality of questionnaires. The difficulty level may be scaled in a range of 0-10. More specifically, the difficulty level of each questionnaire of the plurality of questionnaires may be scaled in the range of 0-10, wherein the difficulty level is increased with the increase in the scale from 0 to 10. In one embodiment, the profile of each user of the plurality of users may be matched with the complexity index value of the complexity index value of each questionnaire of the plurality of questionnaires. Further, at least one questionnaire from the plurality of questionnaires may be assigned to the user based upon the matching of the profile of the user with the complexity index value of the at least one questionnaire.

While aspects of described systems and methods for assigning at least one questionnaire from a plurality of questionnaires to a user may be implemented in any number of different computing systems, environments, and/or configurations, the embodiments are described in the context of the following exemplary system. Thus, the following more detailed description of the embodiments of the disclosure, as represented in the figures and flowcharts, is not intended to limit the scope of the disclosure, as claimed, but is merely representative of certain examples of presently contemplated embodiments in accordance with the disclosure.

The presently described embodiments will be best understood by reference to the drawings, wherein like parts are designated by like numerals throughout. Moreover, flowchart and block diagrams in the Figures illustrate the architecture, functionality, and operation of possible implementations of systems and methods according to various embodiments of the present disclosure. In this regard, each block in the flowchart or block diagrams may represent a module, segment, or portion of code, which comprises one or more executable instructions for implementing the specified logical function(s).

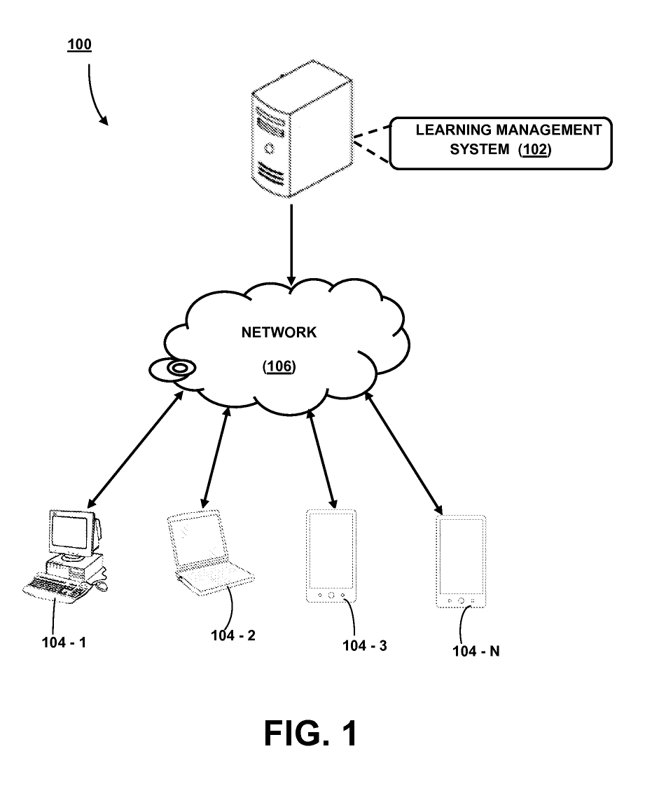

Referring now to FIG. 1, a network implementation 100 of a learning management system 102 for assigning at least one questionnaire from a plurality of questionnaires to a user is illustrated, in accordance with an embodiment of the present subject matter. In an embodiment, the learning management system 102 may capture transactional data and log data associated with activities performed by each user of a plurality of users. The learning management system 102 may analyze the transactional data and the log data to retrieve a first set of parameters and a second set of parameters. The first set of parameters may be indicative of evaluation of each user of the plurality of users based on the activities performed. The second set of parameters may be indicative of evaluation of complexity of each questionnaire of the plurality of questionnaires. The learning management system 102 may generate a profile for each user of the plurality of users by analyzing the first set of parameters. The learning management system 102 may determine a complexity index value of each questionnaire of the plurality of questionnaires by analyzing the second set of parameters. The learning management system 102 may match the profile of each user with the complexity index value of each questionnaire. The learning management system 102 may further assign at least one questionnaire from the plurality of questionnaires to the user based upon the matching of the profile of the user with the complexity index value of the at least one questionnaire.

Although the present subject matter is explained considering that the learning management system 102 is implemented on a learning management server, it may be understood that the 102 may also be implemented in a variety of computing systems including a laptop computer, a desktop computer, a notebook, a workstation, a mainframe computer, a server, a network server and the like. It will be understood that the learning management system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 may be communicatively coupled to the learning management system 102 through a network 106.

In one implementation, the network 106 may be a wireless network, a wired network or a combination thereof. The network 106 may be implemented as one of the different types of networks, including intranet, local area network (LAN), wide area network (WAN), the internet, and the like. The network 106 may either be a dedicated network or a shared network. The shared network may represent an association of the different types of networks that use a variety of protocols comprising a Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

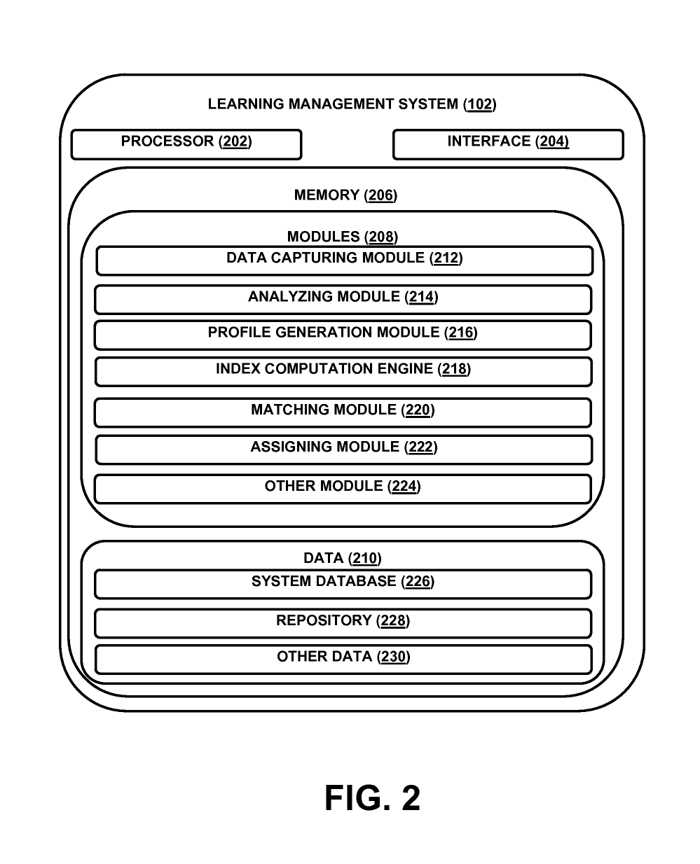

Referring now to FIG. 2, the learning management system 102 is illustrated in accordance with an embodiment of the present subject matter. In one embodiment, the learning management system 102 may include a processor 202, I/O interface 204, and a memory 206. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 may be configured to fetch and execute computer-readable instructions stored in the memory 206.

The I/O interface 204 may include a variety of software and hardware interfaces comprising a web interface, a graphical user interface, and the like. The I/O interface 204 may allow the learning management system 102 to interact with a user directly or through the user devices 104. Further, the I/O interface 204 may enable the learning management system 102 to communicate with other computing devices including web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 may include routines, programs, objects, components, data structures, etc., which facilitate a processor to execute particular tasks, or which implement particular data types. In one implementation, the modules 208 may include a data capturing module 212, an analyzing module 214, a profile generation module 216, an index computation engine 218, a matching module 220, an assigning module 222 and other module 224. The other module 224 may include programs or coded instructions that supplement applications and functions of the learning management system 102.

The data 210, amongst other things, serves as a repository for storing data processed, received, and generated by one or more of the modules 208. The data 210 may also include a system database 226, a repository 228 and other data 230. The other data 230 may include data generated in response to the execution of one or more modules in the other module 224.

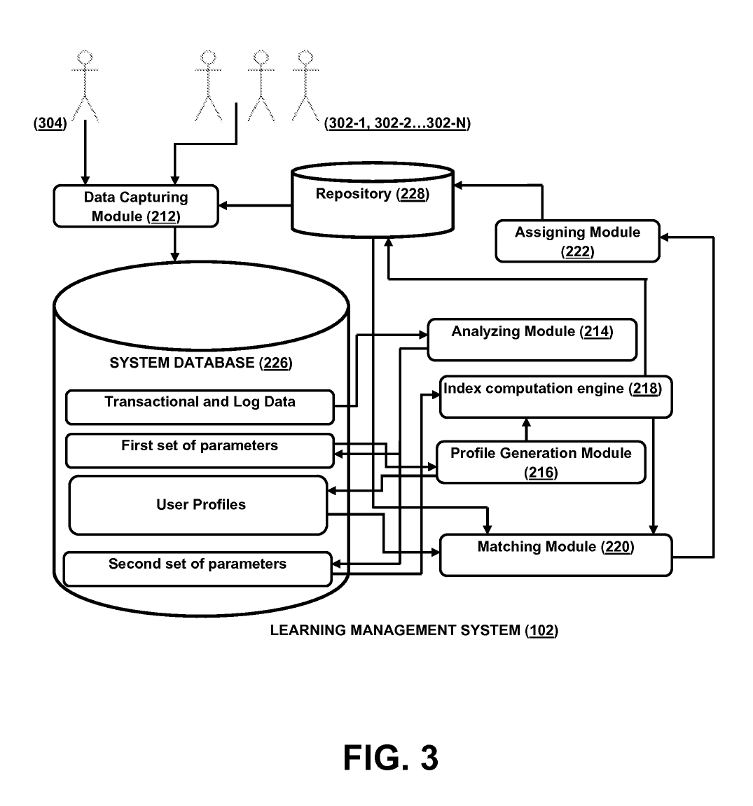

In one implementation, at first, a user may use at least one of the user devices 104 to access the learning management system 102 via the I/O interface 204. The user may register using the I/O interface 204 in order to use the learning management system 102. The working of the learning management system 102 is explained in detail in FIG. 3 explained below. The learning management system 102 may be used for assigning at least one questionnaire from a plurality of questionnaires to a user.

Referring to FIG. 3, a detailed working of the components of the learning management system 102 is illustrated, in accordance with an embodiment of the present subject matter. In one implementation, the repository 228 may be configured to store a plurality of questionnaires. The plurality of questionnaires may comprise at least one of a quiz, a question, a multiple choice question (MCQ), a puzzle, a subjective question, an objective question and a combination thereof. In an embodiment, a plurality of users 302-1, 302-2 . . . 302-N, hereinafter referred as users 302, may be enabled to perform activities on a plurality of entities. The plurality of entities may comprise an assessment, a class, a forum, a quiz, a course, a grade-book, an analytics, a virtual classroom, a program and a combination thereof. The assessment may enable each user of the users 302 to attempt at least one questionnaire from the plurality of questionnaires. The data capturing module 212 may be configured for capturing transactional data and the log data associated with the activities performed by the users 302. The activities performed by the users 302 may comprise at least one of attempting at least one questionnaire from the plurality of questionnaires, publishing a post in the forum, participating in the quiz, navigating content of the course and a combination thereof. In one example, the transactional data may comprise a score obtained in at least one of the quiz, the forum and the questionnaire, amount of content referred in the course, number of questionnaire attempted, peer points obtained in the forum and a combination thereof. Further, the log data may comprise time spent on at least one of the course, the quiz, the questionnaire and the forum, number of quizzes attempted, number of forums initiated, number of substantive posts in the forums and a combination thereof. The transactional data and the log data may be stored in the system database 226.

In one embodiment, the analyzing module 214 may be configured for analyzing the transactional data and the log data to retrieve a first set of parameters and a second set of parameters. In one embodiment, the transactional data and the log data may be captured in an unstructured form. The transactional data and the log data in unstructured form may be processed by using extraction, transformation and loading (ETL) process to derive a structured data. The structured data may then be processed further to obtain the first set of parameters and the second set of parameters. The first set of parameters and the second set of parameters may be stored in the system database 226. In one embodiment, the first set of parameters may be indicative of evaluation of each of the users 302 based on the behavioral activities performed. Further, the second set of parameters may be indicative of evaluation of complexity of each questionnaire of the plurality of questionnaires based upon the attempting of at least one questionnaire from the plurality of questionnaires by each of the users 302. In one example, the first set of parameters may comprise at least at least one of a score, a time, a participation level, an adaptive learning and a practice level. On the contrary, the second set of parameters may comprise at least one of rate of appearance, attempt rate, attempt time and question comparative value.

In one embodiment, the profile generation module 216 may be configured to generate a profile for each user of the plurality of users 302 by analyzing the first set of parameters. The profile of each user of the plurality of users 302, referred hereinafter as “user profiles” may be stored in the system database 226. The index computation engine 218 may be configured to determine a complexity index value of each questionnaire of the plurality of questionnaires by analyzing the second set of parameters. The complexity index value may be an indicative of difficulty level of each questionnaire of the plurality of questionnaires. In one embodiment, the difficulty level may be scaled in the range of 0-10, where the complexity of each questionnaire of the plurality of questionnaires may increase with the increase in the scale from 0 to 10.

In an exemplary embodiment, the determination of complexity index value of each questionnaire of the plurality of questionnaires is described in detail as below. In order to determine the complexity index value of each questionnaire, the second set of parameters including the rate of appearance of each questionnaire, attempt rate of each questionnaire, question comparative value and attempt time of each questionnaire may be analyzed. In an exemplary embodiment, the rate of appearance may indicate the number of times each questionnaire may have appeared on the assessment entity of the learning management system 102. This is a numeric data which takes into account the number of users who would have been exposed to each questionnaire of the plurality of questionnaires. The attempt time may indicate the total time spent on each questionnaire of the plurality of questionnaires and the total number of times a user visits each questionnaire of the plurality of questionnaires. The attempt rate of each questionnaire of the plurality of questionnaires may be derived on the basis of the following parameters:
Number of times correct response marked: This may indicate the number of times each questionnaire of the plurality of questionnaires has been responded correctly by the users 302, over single or multiple exposures.
Number of times wrong response marked: This may indicate the number of times each questionnaire of the plurality of questionnaires has been responded incorrectly by the users 302, over single or multiple exposures.
Number of times not attempted: This may indicate the number of times each questionnaire of the plurality of questionnaires has not been attempted by the users 302, over single or multiple exposures.

In an embodiment, the user profiles generated by the profile generation module 216 may represent a profile of each of the users 302 being exposed to each questionnaire of the plurality of questionnaires stored in the repository 228. The user profiles may enable in evaluating the complexity of each questionnaire of the plurality of questionnaires. This is achieved by exposing each user to each questionnaire of the plurality of questionnaires. Such exposure may help in identifying the users providing a correct response, an incorrect response and users not providing a response at all for each questionnaire of the plurality of questionnaires. In an embodiment, the user profiles, also referred hereinafter as “attempter profiles” interchangeably may be derived using the first set of parameters comprising a score, time spent, practice level, an adaptive learning and participation level associated with each of the users during attempting of each questionnaire of the plurality of questionnaires.

In an exemplary embodiment, the parameter “score” may be derived based on sub-parameters including but not limited to the score on assessments (Only scores on assessment that are published except peer points), the score on Quiz and the score on Forums. The parameter “time spent” may be derived based on sub-parameters including but not limited to the time spent on the course contents, the time spent on practice & graded quizzes and the time spent on forums. Similarly, the parameter “practice level” may be derived based on sub-parameters including but not limited to number of practice quizzes taken by each of the users 302, number of course contents explored, and number of forums initiated in any format. Finally, the parameter “participation level” may be derived based on sub-parameters including but not limited to number of assessments completed, participation points, number of substantive posts on the forums and the peer points obtained on the forums.

In one embodiment, the complexity index value may be determined by statistically analyzing the first set of parameters and the second set of parameters. In order to achieve this, the first set of parameters and the second set of parameters may be initially normalized by the index computation engine 218. The first set of parameters and the second set of parameters may be normalized by following two methods:
Ratio Method and
Min-Max Method

In an exemplary embodiment, the ratio method may be used for normalizing the sub-parameters of the first set of parameters including but not limited to score on assessments, score on quiz, score on forums, number of contents explored, number of assessments completed and the peer points obtained on the forums. All the parameters which have a maximum value are considered as follows:

$$Final Value = \frac{Value}{Max . value}$$

Here value indicates the raw value whereas the final value is the parameter which is to be used for the determination of the complexity index value. “Max.Value” is the max possible value that parameter can take. For example, if the score on an assessment is 16 on 20, then the value=16 and maximum value=20 implies that the final value= 16/20=0.8.

In an exemplary embodiment, the Min-Max method may be used for normalizing the sub-parameters of the first set of parameters including but not limited to time spent on course contents, time spent on practice quizzes, time spent on forums, number of practice quizzes taken, number of forums initiated and number of substantive posts. In the Min-Max method, a raw value of each of the sub-parameters may be transformed as below:

$$Final Value = \frac{Value - Min . Value}{Max . Value - Min . Value}$$

Here value indicates the raw value whereas the final value is the parameter which is to be used for the determination of the complexity index value. Max/Min value is the max/min possible value that parameter can take. For example, if the time spent on the learning content by a user ‘i’ is 30 minutes and the maximum time spent on the learning content by another user T in the class is 60 minutes and min time spent by one of users is 10 minutes then the final value of the time spent is:

$$= \frac{30 - 10}{60 - 10} = \frac{20}{50} = 0.4$$

In one embodiment, subsequent to the normalization of the first set of parameters and the second set of parameters, the index computation engine 218 may be configured for determining the complexity index value of each questionnaire of the plurality of questionnaires. The complexity index value may be determined by initially calculating the attempter profiles based on the first set of parameters as below:

$$Score = \frac{\begin{matrix}Score on Assignments + Score on Quiz + \\ Score on Forums\end{matrix}}{3}$$

$$Practice = \frac{Practice quiz + loud book + assignment}{3}$$

$$Time spent = \frac{\begin{matrix}Loud book + forum + practice quiz + \\ Analytics + Virtual Classroom\end{matrix}}{5}$$

$$Participation = \frac{\begin{matrix}Forums + assignments + \\ participation points + peer points\end{matrix}}{4}$$

$$And$$

$$Adaptive Learning = \frac{Language Complexity Score + Conceptual Level Score}{2}$$

Once these parameters are calculated, regression technique is applied on the parameters, to arrive at the three coefficients β1, β2, β3 & β4 as follows:

Score=β1×Practice+β2×Time spent+β3×Participation+β4×Adaptive Learning

The regression may be applied only after the information of all the parameters which are included in the complexity index value is available appropriately. So the time frame may be selected accordingly. As frequency of running the regression is concerned it may be applied at the same instance as the complexity index value is being calculated. Once the coefficients have been calculated using the regression equation, the coefficients are used to calculate the weights for calculating the final attempter profile value in the following way:

$$Weight of Score ( Ws ) = \frac{1}{1 + β 1 + β 2 + β 3 + β 4}$$

$$Weight of Practice ( Wp ) = \frac{β1}{1 + β 1 + β 2 + β 3 + β 4}$$

$$Weight of Time spent ( Wt ) = \frac{β 2}{1 + β 1 + β 2 + β 3 + β 4}$$

$$Weight of Participation ( Wpa ) = \frac{β3}{1 + β 1 + β 2 + β 3 + β 4}$$

$$Weight of Adaptive Learning ( Wal ) = \frac{β4}{1 + β 1 + β 2 + β 3 + β 4}$$

$$Attempter Profile = Ws \times Score + Wp \times Practice + Wt \times Time + Wpa \times Participation + Wal X Adaptive Learning$$

Once the performance metric is obtained, the index computation engine 218 may calculate the attempt rate parameter. The calculation of the attempt rate parameter may be done using following nine sub-parameters, hereinafter also referred as valid parameters:

No. of right attempts with no changes

No. of wrong to right changes

No. of right to right changes

No. of wrong attempts with no changes

No. of wrong to wrong changes

No. of right to wrong changes

No. of right to deselect

No. of wrong to deselect

No. of un-attempted

In an embodiment, the above valid parameters may be indicative of analysis of attempts (either right or wrong) made by each user of a plurality of users while solving questionnaires and changes made (either right or wrong) to each such attempt. Such analysis may enable in assessing the complexity level of each questionnaire of the plurality of questionnaires. Further, one of the valid parameter “No. of right to right changes” may be obtained only for the questionnaires that are part of a Multiple Choice Questions having facility to provide multiple responses.

Each of the above mentioned valid parameters are classified with respect to the attempter's performance. A vector of 10 dimensions may be used to classify users on the performance scale. The users' performance vector is as follows (0-10, 10-20, 20-30, 30-40, 40-50, 50-60, 60-70, 70-80, 80-90, 90-100) percentile. For example if there are 30 attempters and 2 get it correct, 10 get it wrong and 18 leave it un-attempt then the correct index is calculated as follows:

Correct=2 then, this (0, 0, 0, 0, 0, 0, 0, 0, 0, 2) implies the 2 users who have got it correct come from the top performers group. Once the above mentioned classification is done then the vector is normalized by dividing the vector with total number of corrects which gives a vector (0, 0, 0, 0, 0, 0, 0, 0, 0, 1) now this vector is scalar multiplied by the vector (1, 2, 3, 4, 5, 6, 7, 8, 9, 10), which indeed gives a scalar as follows:

1*0+2*0+3*0+4*0+5*0+6*0+7*0+8*0+9*0+10*1=10.

In an embodiment, for example, for wrong i.e. 10, the 10 users are classified into the vector as per their attempter profile. If the 10 users are from 100% group then the vector becomes (0, 0, 0, 0, 0, 0, 0, 0, 0, 10). If the 2 come from 90% tile group and 8 from 100% tile group then vector becomes (0, 0, 0, 0, 0, 0, 0, 0, 2, 8). Similarly the scalar products of number of wrongs and Un-attempted are also calculated. So, the index for corrects, incorrect and attempted is obtained as below:

$$Attempt rate = \frac{Sum of values of valid parameters}{9}$$

In one aspect, subsequent to the calculation of the attempt rate, another parameter namely “rate of appearance” may be calculated by the index computation engine 218. The rate of appearance may be calculated by comparing absolute value of appearances of a particular question with the number of appearance of other questions. The ratio of the absolute value of appearance of the particular question and the other questions is a measure of the rate of appearance for that particular question. In one embodiment, the rate of appearance may be calculated by using the below mentioned formula:

$$Rate of appearance = \frac{\begin{matrix}Sum of no . of appearance of a particular \\ question ( present in some {}_{}^{′}{x }{}_{}^{′} course ID )\end{matrix} }{\begin{matrix}Sum of no . of appearance of all \\ the questions present in same course ID {}_{}^{′}{x}{}_{}^{′}\end{matrix}}$$

In one example, consider a question (Q1) appearing in three different quizzes (quiz 1, quiz 2 and quiz 3) on the learning management system 102, wherein each quiz may comprise 10 different questions. Consider three different groups namely P1, P2 and P3 comprising of four students each, wherein each student of each group is being exposed to multiple questions in each of the quiz 1, quiz 2 and quiz 3. In one example, consider the number of appearances of the question Q1 to be attempted by each of the four students of P1 may be 6, 6, 5 and 6 respectively. Therefore, the total number of appearances for the question Q1 in the group P1 will be 23. Based on same logic, consider the total number of appearances for Q1 in the groups P2 and P2 may be 18 and 15 respectively. Thus, the total number of appearances for the question Q1 (considering quiz 1, quiz 2 and quiz 3) may be 56. Similarly, based on the aforementioned criteria, the total number of appearances of the question Q1 to be attempted by each of the four students in the other groups (P2, P3) may be determined. Based upon the entire analysis of the question Q1 appearing in the quiz 1, quiz 2 and quiz 3 and considering all the groups P1 P2 and P3, a relation score for the question Q1 may be obtained. The relation score may be indicative of the total number of appearances of the question Q1 in the groups P1, P2 and P3. Similarly, the relation score may be determined for the other questions of the questionnaires, based upon which the complexity of each question may be determined. Specifically, the total number of appearances for each question (based on entire analysis for quiz 1, quiz 2 and quiz 3) may be compared to the total number of appearances of the other questions to determine the complexity level of the each question as compared to the other questions.

In one aspect, subsequent to the calculation of the rate of appearance, another parameter namely “time spend rate” for each questionnaire may be calculated by the index computation engine 218. The time spend rate refers to an average time spent on a particular questionnaire in comparison with other questionnaire by each of the users 302. The complexity of a questionnaire may increase with the increase in the attempt time of the said questionnaire. In one embodiment, the time spend rate may be calculated by using the below mentioned formula:

$$Time spend rate = \frac{\begin{matrix}Total time to solve a question \\ ( present in some {}_{}^{′}{x }{}_{}^{′} course ID )\end{matrix} }{\begin{matrix}Total time to solve all the questions \\ present in same course ID {}_{}^{′}{x}{}_{}^{′}\end{matrix}}$$

In one example, consider a question (Q1) appearing in three different quizzes (quiz 1, quiz 2 and quiz 3) on the learning management system 102, wherein each quiz may comprise 10 different questions. Consider three different groups namely P1, P2 and P3 comprising of four students each, wherein each student of each group is being exposed to multiple questions in each of the quiz 1, quiz 2 and quiz 3. In one example, consider the time spent on the question Q1 by each of the four student of P1 may be 6, 6, 5 and 6 respectively. Therefore, the total time spent by the group P1 on the question Q1 will be 23. Based on same logic, consider the total time spent by the groups P2 and P2 may be 18 and 15 respectively. Thus, the total time spent on the question Q1 (considering quiz 1, quiz 2 and quiz 3) may be 56. Similarly, based on the aforementioned criteria, the total time spent on the question Q1 by the students in the other groups (P2, P3) may be determined. Based upon the entire analysis of the question Q1 appearing in the quiz 1, quiz 2 and quiz 3 and considering all the three groups P1, P2 and P3, a relation score for the question Q1 may be obtained. The relation score may be indicative of total time spent on the question Q1 by the students of the groups P1, P2 and P3. Similarly, the relation score may be determined for the other questions of the questionnaires, based upon which the complexity of each question may be determined. Specifically, the total time spent for each question (based on entire analysis for quiz 1, quiz 2 and quiz 3) may be compared to the total time spent for the other questions to determine the complexity level of the each question as compared to the other questions.

In one aspect, the index computation engine 218 may be further configured to calculate another parameter namely “Question Comparative Value”. The Question Comparative Value refers comparing actual position and attempting position of each questionnaire. Specifically, the user may selectively attempt a questionnaire from multiple questionnaires irrespective of its position in the multiple questionnaires. That is the actual position of each questionnaire and the attempting position of the each questionnaire may vary. Such variation in the positions enables to compute the Question Comparative Value. Based on the comparison of actual and attempting positions of the each questionnaire, the index computation engine 218 may assign a score to the each questionnaire, wherein the score assigned may refer to the Question Comparative Value calculated for the each questionnaire. In one embodiment, the score may be assigned based on below logic:

Attempting Position>Original Position Then score=1=>Complex

Attempting Position=Original Position Then score=0=>Average

Attempting Position<Original Position then score=−1=>Easy

In one example, consider a question Q1 appearing in three different quizzes quiz 1, quiz 2 and quiz 3 on the learning management system 102. Consider the original position of the question Q1 in each of the three different quizzes may be 7, 2 and 9 respectively, wherein each quiz may comprise 10 different questions. Consider three different groups namely P1, P2 and P3 comprising of four students each, wherein each student of each group is being exposed to multiple questions in each of the quiz 1, quiz 2 and quiz 3. In one example, consider the attempting positions of each student of P1 for the question Q1 in the quiz 1 may be 6, 6, 5 and 6 respectively. Now, based on the above logic, the question Q1 of the quiz 1 may be assigned a score of −1, −1, −1 and −1 respectively. Further, based on the score assigned for a particular group (P1 in this case), a mode for the question may be determined.

In one embodiment, the mode for the question Q1 may be indicative of a similar score obtained consistently based on attempting position of each student of a group. That is in present scenario, the mode of the question may be −1, since for all the four students, the attempting position is less than the original position and hence assigned with a score −1 each. Similarly, based on the aforementioned criteria, mode for the other groups (P2, P3) may be determined. Also, the index computation engine 218 may be configured for assigning score to the question Q1 based on its appearance in the quiz 2 and quiz 3 for the groups P1, P2 and P3, and accordingly, depending on which the mode for the question in the quiz 2 and the quiz 3 may be determined. Based upon the entire analysis of the question Q1 appearing in the quiz 1, quiz 2 and quiz 3, a relation score for the question may be obtained. The relation score may be indicative of a mode of mode determined for each of the groups P1, P2 and P3. That is the relation score may be at least one of 1, 0 and −1 indicating complex, average and easy respectively. Similarly, the relation score may be determined for the other questions of the questionnaires which may indicate the complexity level of the questions.

In one embodiment, after all the above parameters namely “attempt rate”, “question comparative value”, “time spend rate” and “rate of appearance” are determined, the index computation engine 218 may be configured for determining the complexity index value for each questionnaire of the plurality of questionnaires. The complexity index value, also referred hereinafter as “Question Index” may be determined using the below mentioned formula:

$$QuestionIndex = \frac{\begin{matrix}Attemptrate + Question Comparative Value + \\ Attempttime + No . of Appearance\end{matrix}}{4}$$

In an alternative embodiment, the parameters “attempt rate”, “question comparative value”, “time spend rate” and “rate of appearance” may be standardized initially and then the complexity index value for each questionnaire of the plurality of questionnaires may be determined based upon the standardized value of each of the parameters. The standardized value of the attempt rate, the question comparative value, the time spend rate and the rate of appearance may be obtained as below:

Standardized Attempt Rate=(Attempt Rate)/10

Standardized Question Comparative Value=(Question Comparative Value)/3

Standardized Time Spend=(Time Spend)/1

Standardized Rate of Appearance=(Rate of Appearance)/1

Now, based on the standardized value of each of the parameters, the index computation engine 218 may be configured for determining the complexity index value for each questionnaire of the plurality of questionnaires. In this alternative embodiment, the complexity index value, also referred hereinafter as “standardized QuestionIndex” may be determined using the below mentioned formula:

$$Standardized Question Index = \frac{\begin{matrix}Standardized Attempt Rate + Standardized Question \\ Comparative Value + Standardized Time Spend + \\ Standardized Rate of Appearance\end{matrix}}{4}$$

In an embodiment, the index computation engine 218 while determining the complexity index value of each questionnaire of the plurality of questionnaires in the above illustrations may assume following scenarios:
Ranking at the attempter's level done at historical level and with an assumption that a user with better track record will answer more questions.
Degree of difficulty of the question increases as the average time take to solve the question increases.
Degree of difficulty of the question decreases with increase in the number of appearances of the question.
The final performance of a user is assumed to be caused by the time spent, practice and participation.
   Here user means a student attempting the electronic assessments stored in the repository 228.

In an exemplary embodiment, the complexity index value may be made more robust by tracking the time taken by an “attempter” or at least one of the users 302 to respond to each questionnaire in relation to its sequence of appearance. Further, the calculation may be made more robust by tracking the usage of analytics by each user linked to performance.

Time to Question: This works on an assumption, that any attempter, if given the flexibility will attempt the easiest questions first and then move on to more difficult questions. The parameter may also be used to test each user's response to a question when it appears across different times. It is proposed to be checked using the following two parameters:
Sequence: Here sequence is the order in which a particular questionnaire is attempted
Proportionate time: This parameter may indicate the ratio of time taken by each user to reach a specific questionnaire by the total time of the quiz/assessment etc.

Feedback:

Feedback from the user can take into consideration time spent on analytics, instructor initiated posts, Comments in a forum by an instructor. Feedback as a parameter can be added to the attempter's profile, as it is an inclusive part of learning.

In an embodiment, subsequent to determination of the complexity index value, the matching module 220 may be configured to match the profile of each of the users 302 to each questionnaire of the plurality of questionnaires stored in the repository 228. This may help in identifying a specific questionnaire being matched to a specific profile so that the users having a profile similar to said specific profile may be assigned with the specific questionnaire by the learning management system 102 using the assigning module 222. Specifically, based upon the matching of the profile of each user of the users 302 with the complexity index value of each questionnaire of the plurality of questionnaires, the assigning module 222 may be configured to assign at least one questionnaire from the plurality of questionnaires to the users 302. The assigning module 222 may be configured for assigning at least one questionnaire from the plurality of questionnaires either to a new user 304 on the learning management system 102 or at least one of the users 302 who has visited the entities of the learning management system 102 at least once, so that the profile of each user is generated, and accordingly, at least one questionnaire from the plurality of questionnaires may be assigned. In an exemplary embodiment, for example, consider the profile of the new user 304 is matched with an attempter's profile score of 7 and from availability of the matching between the category of questionnaire the new user 304 likes, it is determined that the new user 304 can solve multiple-choice questions (MCQs) better than other questionnaire types. Then the learning management system 102 may be enabled to improve the questionnaire solving skills of the new user 304 on the other questionnaires including but not limited to fill in the blanks, and match the following etc. by designing a quiz which has less MCQ's and more other questions which are around the difficulty range of 7. Such matching helps in improving the question category appetite of the new user 304.

Exemplary embodiments discussed above may provide certain advantages. Though not required to practice aspects of the disclosure, these advantages may include the following.

The present disclosure enables capturing and analyzing students' performance on individual questions, attempts, quizzes, time-taken, and scores etc.

The present disclosure enables longitudinal analysis of questions, quizzes so as to generate trends, complexities, and weights etc for questions that can be assigned to students

The present disclosure enables capturing and processing the data related to student's online learning pattern and behavior, in specific reference to improving the level of tasks they get exposed to and ensure better learning.

The present disclosure further enables to process the parameters representing the user learning behavior.

The present disclosure further enables to optimize usage of internal tasks or question banks

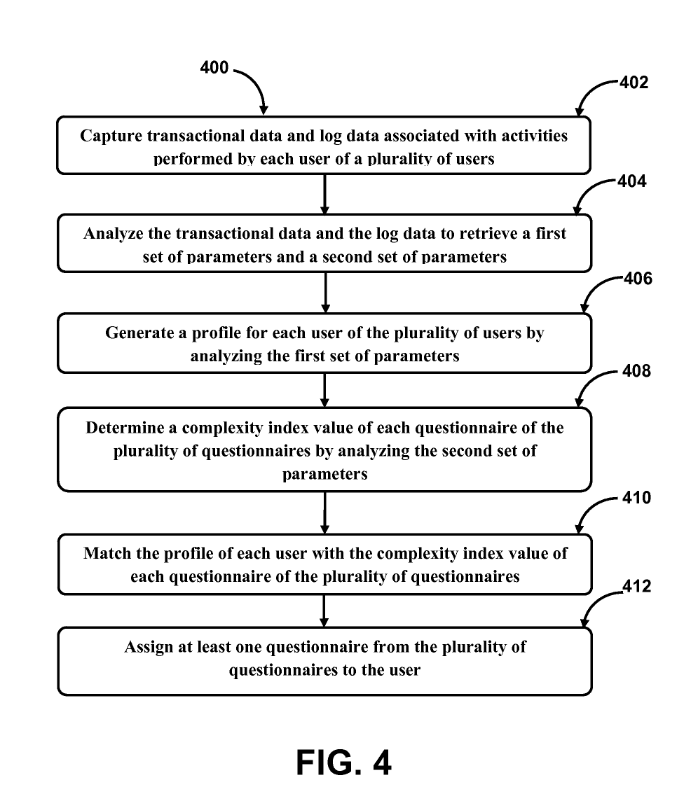

Referring now to FIG. 4, a learning management method 400 for assigning at least one questionnaire from the plurality of questionnaires to a user is shown, in accordance with an embodiment of the present subject matter. The learning management method 400 may be described in the general context of computer executable instructions. Generally, computer executable instructions can include routines, programs, objects, components, data structures, procedures, modules, functions, etc., that perform particular functions or implement particular abstract data types. The learning management method 400 may also be practiced in a distributed computing environment where functions are performed by remote processing devices that are linked through the network 106. In a distributed computing environment, computer executable instructions may be located in both local and remote computer storage media, including memory storage devices.

The order in which the learning management method 400 is described is not intended to be construed as a limitation, and any number of the described method blocks can be combined in any order to implement the learning management method 400 or alternate methods. Additionally, individual blocks may be deleted from the learning management method 400 without departing from the spirit and scope of the subject matter described herein. Furthermore, the learning management method can be implemented in any suitable hardware, software, firmware, or combination thereof. However, for ease of explanation, in the embodiments described below, the learning management method 400 may be considered to be implemented in the learning management system 102 as described above.

At block 402, transactional data and log data associated with activities performed by each user of a plurality of users may be captured. The transactional data and the log data may be stored in the system database 226. In one implementation, the transactional data and the log data may be captured by the data capturing module 212.

At block 404, the transactional data and the log data may be analyzed to retrieve a first set of parameters and a second set of parameters. The first set of parameters and a second set of parameters may be stored in the system database 226. In one implementation, the transactional data and the log data may be analyzed by the analyzing module 214.

At block 406, a profile for each user of the plurality of users may be generated by analyzing the first set of parameters. The plurality of profiles may be stored in the system database 226. In one implementation, the profile for each user may be generated by the profile generation module 216.

At block 408, a complexity index value of each questionnaire of the plurality of questionnaires may be determined by analyzing the second set of parameters. In one implementation, the complexity index value of each questionnaire may be determined by the index computation engine 218.

At block 410, the profile of each user may be matched with the complexity index value of each questionnaire of the plurality of questionnaire. In one implementation, the profile of each user may be matched by the matching module 220.

At block 412, at least one questionnaire of the plurality of questionnaires may be assigned to the user. In one implementation, the at least one questionnaire may be assigned by the assigning module 222. The at least one questionnaire may be assigned based upon the matching of the profile of the user with the complexity index value of the at least one at least one questionnaire.

Although implementations for methods and systems for evaluating the performance of the at least one user while performing at least one entity on the learning management system 102 have been described in language specific to structural features and/or methods, it is to be understood that the appended claims are not limited to the specific features or methods described. Rather, the specific features and methods are disclosed as examples of implementations for assigning questionnaires to users on the learning management system.

I/We claim:

1. A learning management method, comprising:
capturing transactional data and log data associated with activities performed by a plurality of users;
analyzing the transactional data and the log data to retrieve a first set of parameters and a second set of parameters;
generating a profile for each user of the plurality of users by analyzing the first set of parameters;
determining, via a processor, a complexity index value of each questionnaire of a plurality of questionnaires by analyzing the second set of parameters;
matching the profile of each user with the complexity index value of each questionnaire of the plurality of questionnaires;
assigning the at least one questionnaire from the plurality of questionnaires to the user based upon the matching of the profile of the user with the complexity index value of the at least one questionnaire; and
providing the assigned at least one questionnaire.

2. The learning management method of claim 1, wherein the plurality of questionnaires comprises at least one of a quiz, a question, a multiple choice question (MCQ), a puzzle, a subjective question, an objective question, or a combination thereof; and
wherein the plurality of questionnaires are stored in a repository.

3. The learning management method of claim 1, wherein the activities are performed by each user on at least one entity, and wherein the at least one entity is selected from a group consisting of: an assessment, a class, a forum, a quiz, a course, a grade-book a virtual classroom, an Analytics, and a program.

4. The learning management method of claim 3, wherein the activities comprise at least one of: attempting at least one questionnaire in the assessment, publishing a post in the forum, participating in the quiz, navigating a content of the course, or a combination thereof.

5. The learning management method of claim 1, wherein the transactional data comprises at least one of: a score obtained in at least one of a quiz, a forum or an assessment; amount of content referred in the course; number of questionnaires attempted; or peer points obtained in the forum.

6. The learning management method of claim 1, wherein the log data comprises at least one of: time spent on at least one of a course, a quiz, a questionnaire or a forum, number of quizzes attempted, number of forums initiated, number of substantive posts in the forums, or a combination thereof.

7. The learning management method of claim 1, wherein the first set of parameters is indicative of evaluation of each user of the plurality of users based on the activities performed, and wherein the second set of parameters is indicative of evaluation of complexity of each questionnaire of the plurality of questionnaires.

8. The learning management method of claim 7, wherein the first set of parameters comprises at least one of a score, a time, an Adaptive learning parameter, a participation level, or a practice level.

9. The learning management method of claim 7, wherein the second set of parameters comprises at least one of: rate of appearance, attempt rate, attempt time, or a question comparative value.

10. A learning management system, comprising:
a processor; and
a memory coupled to the processor, wherein the processor is capable of executing instructions stored in the memory, the instructions comprising instructions for:
capturing transactional data and log data associated with activities performed by each user of a plurality of users;
analyzing the transactional data and the log data to retrieve a first set of parameters and a second set of parameters;
generating a profile for each user of the plurality of users by analyzing the first set of parameters;
determining a complexity index value of each questionnaire of the plurality of questionnaires by analyzing the second set of parameters;
matching the profile of each user with the complexity index value of each questionnaire of the plurality of questionnaires;
assigning the at least one questionnaire from the plurality of questionnaires to the user based upon the matching of the profile of the user with the complexity index value of the at least one questionnaire; and
providing the assigned at least one questionnaire.

11. The learning management system of claim 10, wherein the plurality of questionnaires comprises at least one of: a quiz, a question, a multiple choice question (MCQ), a puzzle, a subjective question, or an objective question; and
wherein the plurality of questionnaires are stored in a repository.

12. The learning management system of claim 10, wherein the activities are performed by each user on at least one entity, and wherein the at least one entity is selected from a group consisting of: an assessment, a class, a forum, a quiz, a course, a grade-book, a virtual classroom, an Analytics, and a program.

13. A non-transitory computer program product having embodied thereon computer-readable learning management instructions comprising instructions for:
capturing transactional data and log data associated with activities performed by each user of a plurality of users;
analyzing the transactional data and the log data to retrieve a first set of parameters and a second set of parameters;
generating a profile for each user of the plurality of users by analyzing the first set of parameters;
determining a complexity index value of each questionnaire of the plurality of questionnaires by analyzing the second set of parameters;
matching the profile of each user with the complexity index value of each questionnaire of the plurality of questionnaires;
assigning the at least one questionnaire from the plurality of questionnaires to the user based upon the matching of the profile of the user with the complexity index value of the at least one questionnaire; and
providing the assigned at least one questionnaire.
